(19) United States
(12) Patent Application Publication
(10) Pub. No.: US 2007/0130814 A1
(43) Pub. Date: Jun. 14, 2007

(54) Pooch pouch

(76) Inventor: Nicole Block, Highland Park, IL (US)

Correspondence Address: Nicole Block, 459 Red Oak Ln., Highland Park, IL, 60035, US

(21) Appl. No.: 10/756,968

(22) Filed: Nov. 21, 2005

(51) Int. Cl. G09F 3/18

(52) U.S. Cl. 40/661

(57) ABSTRACT

The object is a heat sealed plastic square 2 in″ by 2″ in in diameter. The object is plastic that cover the metal tags of a pet's identification tags. The plastic device fits onto the clip of the collar and holds the pet's tags in place. The device is used to eliminate the metal noise from the pet's id collar the metal clanking noise. The object is made of plastic which is then heat sealed at the sides with an open bottom which then slides onto the circular clip on the pet's collar.

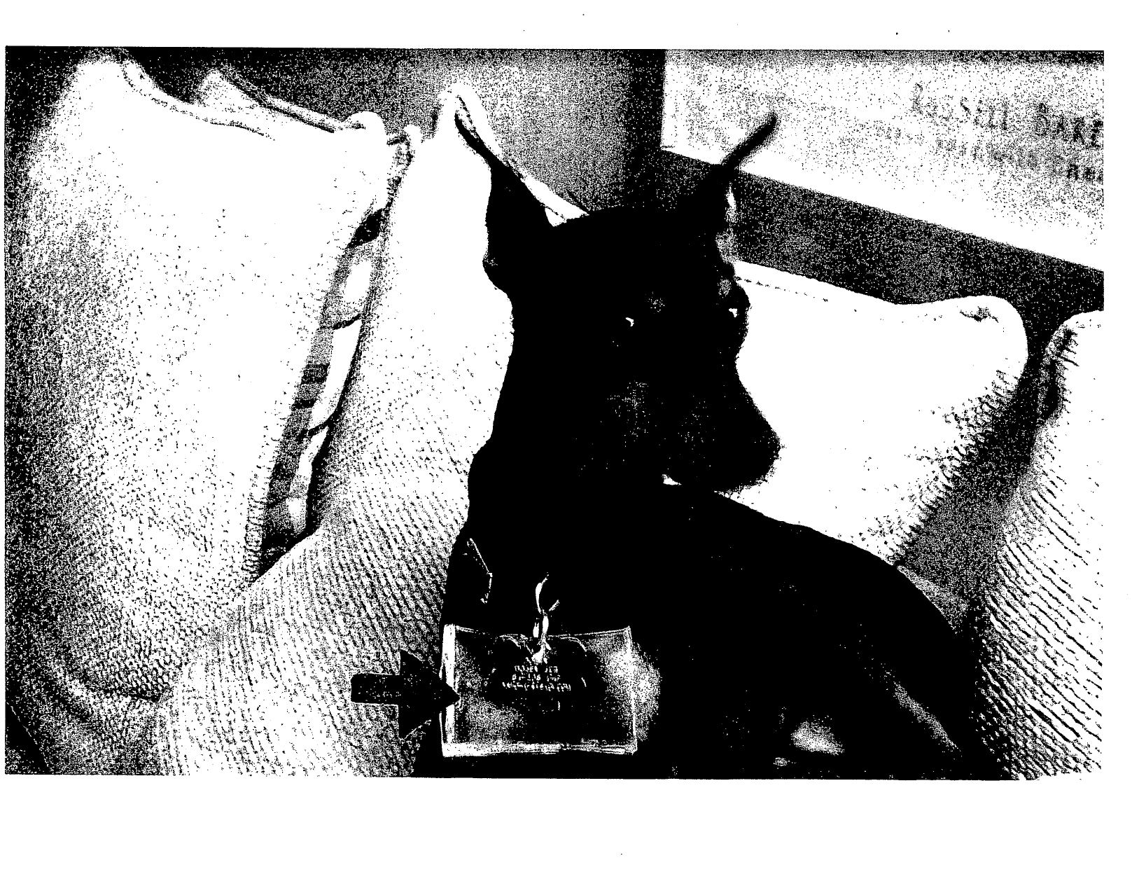

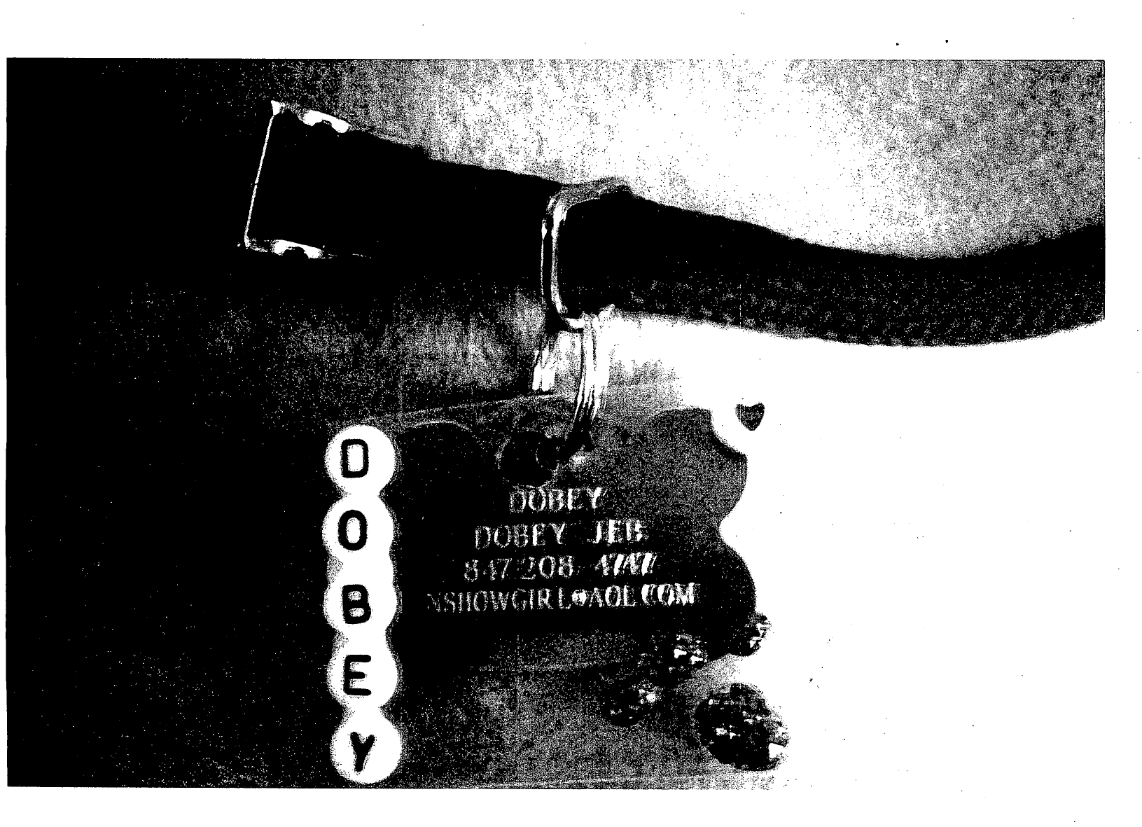

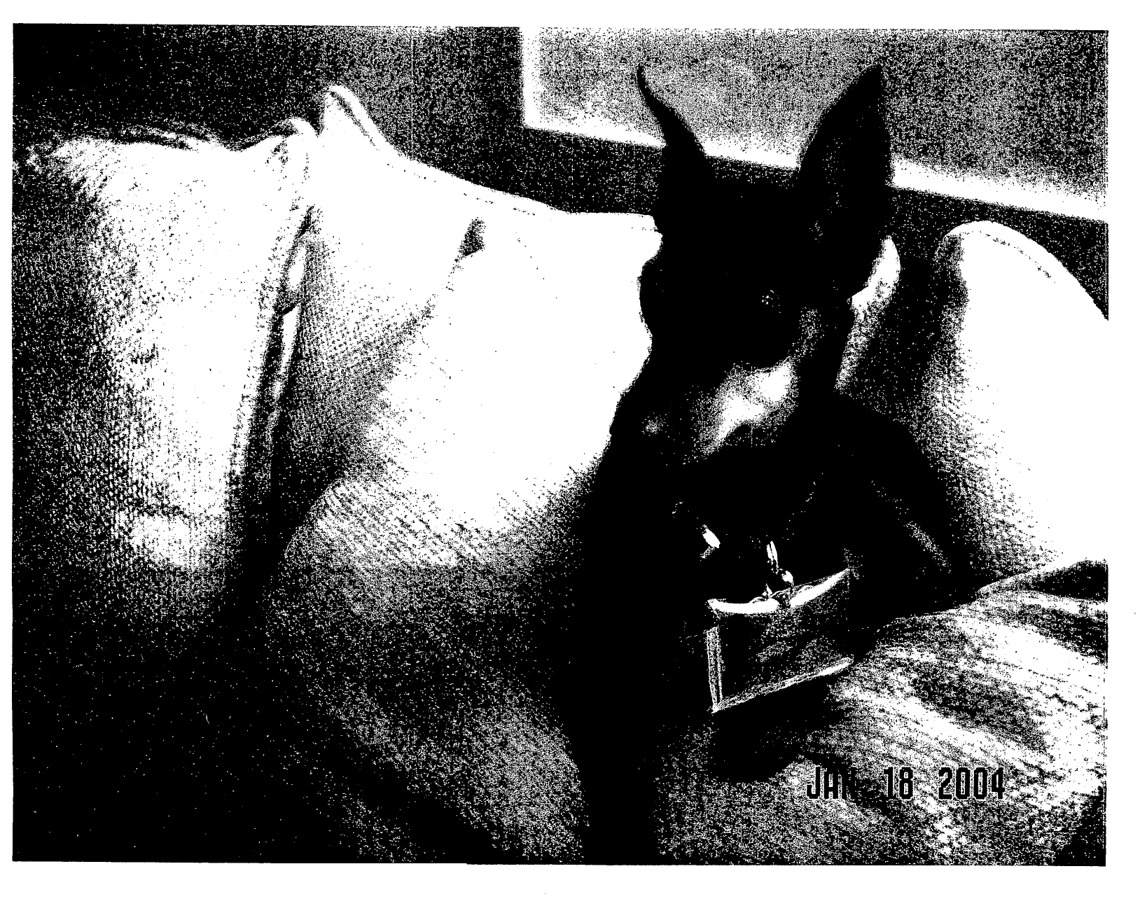

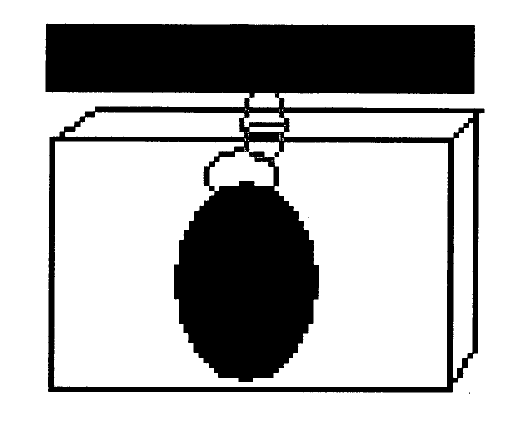

The POOCH POUCH dog tag holder is a clear plastic cover for a Pets ID tags. It eliminates the jingling noise and the clinging of Pet tags.

It is square in plastic that is heat sealed on the sides and it slides right on to the clip that fits over an animal's ID tags. It is made from a non allergenic plastic it is bendable, waterproof, and chewable proof.

It is heat sealed on the sides and allows the Pet's tags to slide through the bottom of the plastic through to the top of the Plastic where it clips on to the bog's ID tags.

There is a is a circular hole to attach on to the ring of the Pet's collar. The Pooch Pouch dimensions vary from 2½ in.×1 in., 2½ in.×1½ in., or 3 in.×1½ in.

It is a wonderful and peaceful item when you are trying to relax, your baby is sleeping, you are trying to watch tv, or you don't want to get awaken it the middle of the night. You hear no noise from the metal of the Pets ID tags. It is very convenient.

This pooch pouch invention came when my little 10 pound miniature pinscher dog was running around the house, jumping, and making so much noise with his jingling dog tags. his pet tags would jingle when I was sleeping in the middle of the night, trying to relax, read a book, watch television, or anything that required any quiet. So I thought it would be a great invention to make a clear, id tag pouch to put over the dog's id tags so they don't jingle and make noise.

So I invented the pooch pouch and I am so excited, it really works.

I am excited that I can make the pooch pouch into different colors for female, and male dogs, or they can be monogrammed. I can enjoy the quiet, and my dog can do anything without the noise disturbing me. I think he really likes it too!

What is claimed is:

1. A device of plastic heat sealed on the sides. The object is 2″ by 2″ in diameter. The object is a square piece of plastic to be used to fit over a pet's ID tags.

2. The object is durable plastic, chewable proof, and waterproof.

3. Device according to claim 1. Is made of clear plastic. That is folded over and heat sealed on both sides to create a pouch to hold the Pet's metal ID tags. Therefore it is a pouch with an open bottom to slide the pet's tags in and out if would like.

4. Device according to claim 1. Is heat sealed on sides to hold the metal tags in place on the pet's collar.

5. Device according to claim 1. Has a circular hole at the top of the 2″ by 2″ plastic to hook the metal circle to the pet's ID tags.

6. Device according to claim 1. Holds pet's ID tags into place so there is no noise inside of plastic.
